(19) United States
(12) Patent Application Publication
(10) Pub. No.: US 2012/0075445 A1
(43) Pub. Date: Mar. 29, 2012

(54) IMAGING DEVICE AND ENDOSCOPIC DIAGNOSIS SYSTEM

(75) Inventor: Masanobu UCHIHARA, Kanagawa (JP)

(73) Assignee: FUJIFILM CORPORATION, Tokyo (JP)

(21) Appl. No.: 13/245,932

(22) Filed: Sep. 27, 2011

(30) Foreign Application Priority Data
Sep. 27, 2010 (JP) 2010-215140

(51) Int. Cl. H04N 5/235; H04N 7/18; H04N 5/217

(52) U.S. Cl. 348/65; 348/241; 348/229.1; 348/E05.079; 348/E05.037; 348/E07.085

(57) ABSTRACT

A mask selector for selecting and setting a mask according to an input instruction and a level selector for selecting a halation reduction level are provided, and a luminance ratio of a first region containing a central area of an acquired image and a second region closer to the periphery thereof is obtained, the mean luminance and the peak luminance of the acquired image are mixed using weighting factors in accordance with the luminance ratio, and a photometric value representing a whole brightness of the acquired image is obtained to adjust the brightness of the acquired image based on the photometric value, the photometric value being obtained according to a peak luminance calculating condition and a weight setting condition preset according to a combination of a selected mask and halation reduction level.

### BACKGROUND OF THE INVENTION

The present invention relates to an imaging device for imaging a subject to acquire an image and an endoscopic diagnosis system equipped with the imaging device.

There has been widely used in medicine endoscope systems whereby an elongated tube equipped with a CCD or the like at its tip is inserted into a body of a subject to image the inside of the subject's body and observe a tumor, a thrombus, and the like. With such endoscopic diagnosis systems, the inside of a subject's body can be directly imaged without inflicting external damage to the subject, and the colors and shape of a lesion, which are difficult to observe with a radiographic image, can be comprehended, thus enabling easy acquisition of information necessary to determine a treatment plan.

Such endoscopic diagnosis systems illuminate the inside of a subject's body to perform imaging by the illumination. Illumination problems, if any, that an acquired image is too dark, a halation occurred during imaging, or the like cause a great hindrance to diagnosis given by a doctor based on acquired images. To avoid such problems related to acquired images, there has been proposed a technique whereby an acquired image is analyzed to measure the brightness of the acquired image, and the illumination with which the inside of a subject's body is illuminated is automatically adjusted to an appropriate illumination based on the brightness obtained.

JP 2009-60237 A, for example, describes an imaging device comprising a comparator for comparing the brightness in a first region containing a central area of an acquired image and the brightness in a second region closer to the edge of the acquired image; a photometer for measuring the brightness of the acquired image as a whole in such a manner that in comparison by the comparator of a mean brightness of the acquired image and the brightness of a high-luminance region in the acquired image, an increasingly greater weight is given to the brightness of the high-luminance region in mixing these brightnesses as the brightness in the first region relative to the brightness in the second region increases; and a condition adjuster for adjusting an imaging condition affecting the brightness of the acquired image based on the measured brightness obtained by the photometer.

According to the imaging device described in JP 2009-60237 A, the brightness in the central area of the image and the brightness in the periphery are compared, and the mean luminance and the high luminance in the whole image are mixed using a weight in accordance with the comparison result to enable automatic adjustment of the brightness in a region on which the doctor's attention is focused for diagnosis, i.e., the central area of the image, to an appropriate brightness.

### SUMMARY OF THE INVENTION

However, the region on which the doctor's attention is focused may lie not in the central area of the image but in the periphery depending on the purpose of diagnosis. In such a case, it is possible that the brightness in the region on which the doctor's attention is focused for diagnosis may not be automatically adjusted to an appropriate brightness.

Further, since the endoscopic diagnosis system basically acquires images of the inside of a substantially tubular site in the subject's body, the distance between the subject and, for example, a CCD imaging the subject is such that the subject is often closer to the periphery than to the central area. Therefore, the light reflected from the subject is greater in the periphery than in the central area, so that a halation occurs more often in the periphery.

Accordingly, when adjustment is made to obtain an appropriate brightness in the central area as in JP 2009-60237 A, a halation may occur in the periphery. When the focus of the doctor's attention for diagnosis lies in the central area of the image, the region on which the doctor's attention is focused for diagnosis is adjusted to an appropriate brightness even when a halation is occurring in the periphery. However, the doctor may still feel uncomfortable even when the halation is occurring in the periphery, and this may hinder the doctor's diagnosis.

When displaying an acquired image, the imaging device may use a mask to define a display region of the image. When a mask is selected for use from a plurality of kinds at hand, the display region varies with the shape of a selected mask. An appropriate brightness for the same image varies with the display region. When a mask covering the periphery, where a halation is liable to occur, is used, for example, adjustment is preferably so made as to increase the brightness provided by the illumination because a halation occurring in the periphery is not a significant problem. However, the device described in JP 2009-60237 A had a problem that it is incapable of adjustment in accordance with the mask.

An object of the present invention is to provide an imaging device and an endoscopic diagnosis system that solve the problems of the prior art and can adjust the brightness of an image to an appropriate brightness even when the region of interest lies in the periphery of the image and adjust the brightness of an image to an appropriate brightness according to a mask used even when the mask is one selected from a plurality of masks.

To achieve the above object, a first aspect of the present invention provides the imaging device for acquiring an image with a solid state image sensor, comprising: a mask selector including a plurality of masks for defining a display region used when displaying an acquired image and selecting a mask according to an input instruction; a reduction level selector for selecting a halation reduction level according to an input instruction used when displaying said acquired image, light measuring means for obtaining a photometric value representing a whole brightness of said acquired image, and brightness adjusting means for adjust an imaging condition affecting the brightness of said acquired image based on said photometric value, wherein said light measuring means comprising; a comparator for comparing said brightness in a first region containing a center of said acquired image and a brightness in a second region closer to a periphery in said acquired image to obtain a luminance ratio between said first region and said second region, a photometric value calculator for calculating a mean luminance and a peak luminance of said acquired image, and mixing said mean luminance and said peak luminance using weighting factors such that, according to said luminance ratio, a weight given to said peak luminance increases as said brightness in said first region relative to the brightness in said second region increases to obtain a photometric value representing the whole brightness of said acquired image, and a condition setting unit for setting a peak luminance calculating condition and a weighting factor to use when said photometric value calculator obtains said photometric value, according to a combination of said selected mask and the halation reduction level.

In this case, it is preferred that said mask includes at least a mask covering four corners of an imaging region of a solid state image sensor and a mask covering a pair of opposite given end regions of a solid state image sensor.

Further, it is preferred that said peak luminance calculating condition is so set that said peak luminance increases as the halation reduction level increases.

Further, it is preferred that said peak luminance calculating condition is so set that said peak luminance increases as said angle of view of said mask increases.

Further, it is preferred that said weighting factor setting condition is so set that a weight given to said peak luminance increases as the halation reduction level increases.

Further, it is preferred that said weighting factor setting condition is so set that a weight given to said peak luminance increases as a angle of view of said mask increases.

Further, it is preferred that said brightness in said first region is a peak luminance of said first region and said brightness in said second region is a peak luminance of said second region.

Alternatively, it is preferred that said brightness in said first region is a mean luminance of said first region and said brightness in said second region is a mean luminance of said second region.

Further, it is preferred that an area ratio of said first region to said acquired image as a whole is 25% to 50%.

Preferably, the imaging device further comprise a light source for illuminating a region to be imaged, and wherein said brightness adjusting means adjusts the imaging condition affecting the brightness of said acquired image by adjusting an amount of light passing through an optical path at a position on the optical path between the light source and the imaging region.

Further, it is preferred that said brightness adjusting means adjusts the shutter speed of an electronic shutter in said solid state image sensor.

To achieve the above object, a second aspect of the invention provides the endoscopic diagnosis system comprising the imaging device according to the first aspect of the present invention.

According to the present invention, a mask selector for selecting and setting a mask according to an input instruction and a level selector for selecting a halation reduction level are provided, and a luminance ratio of a first region containing a central area of an acquired image and a second region closer to the periphery thereof is obtained, the mean luminance and the peak luminance of the acquired image are mixed using weighting factors in accordance with the luminance ratio, and a photometric value representing a whole brightness of the acquired image is obtained to adjust the imaging condition affecting the brightness of the acquired image based on the photometric value, the photometric value being obtained according to a peak luminance calculating condition and a weight setting condition preset according to a combination of a selected mask and halation reduction level, whereby even when a region of interest lies in the periphery, the brightness of the acquired image can be adjusted to an appropriate brightness, while even when a mask is selected from a plurality of masks at hand, the brightness of the acquired image can be adjusted to an appropriate brightness according to a selected mask.

### BRIEF DESCRIPTION OF THE DRAWINGS

FIG. 1 is an external view of an embodiment illustrating a configuration of the endoscopic diagnosis system according to the invention.

FIG. 2 is a block diagram illustrating an internal configuration of the endoscopic diagnosis system of FIG. 1.

FIG. 3 is a block diagram illustrating a configuration of a part of the endoscopic diagnosis system of FIG. 1.

FIGS. 4A and 4B are views schematically illustrating examples of the mask used in the endoscopic diagnosis system of the invention.

FIG. 5A is a schematic view of a still image G; FIG. 5B is a schematic view of a histogram for a central area of an image;

FIG. 5C is a schematic view of a histogram for a periphery of an image; FIG. 5D is a schematic view of a histogram for the whole image.

FIG. 6 is a graph illustrating a correspondence between a ratio (Ych/Ysh) of a central peak luminance Ych to a peripheral peak luminance Ysh and a weight Wp.

### DETAILED DESCRIPTION OF THE INVENTION

The imaging device and the endoscopic diagnosis system according to the present invention will be described in detail based on preferred embodiments illustrated in the attached drawings.

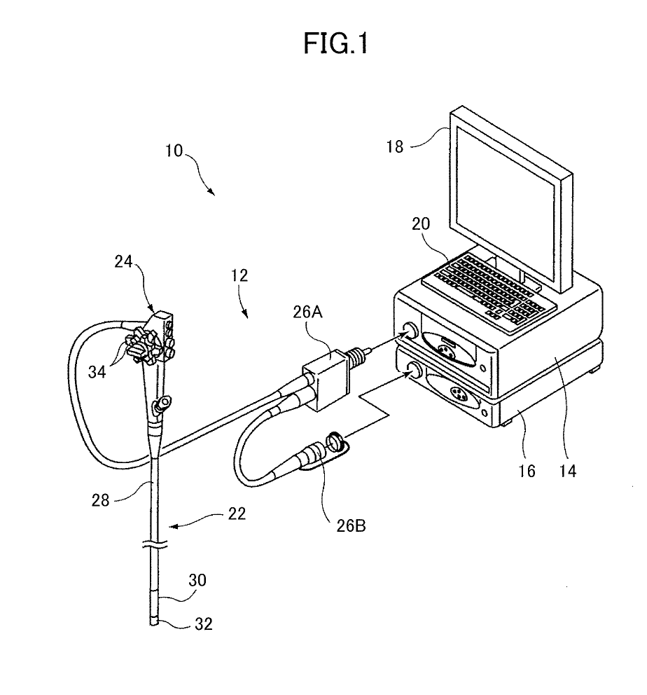

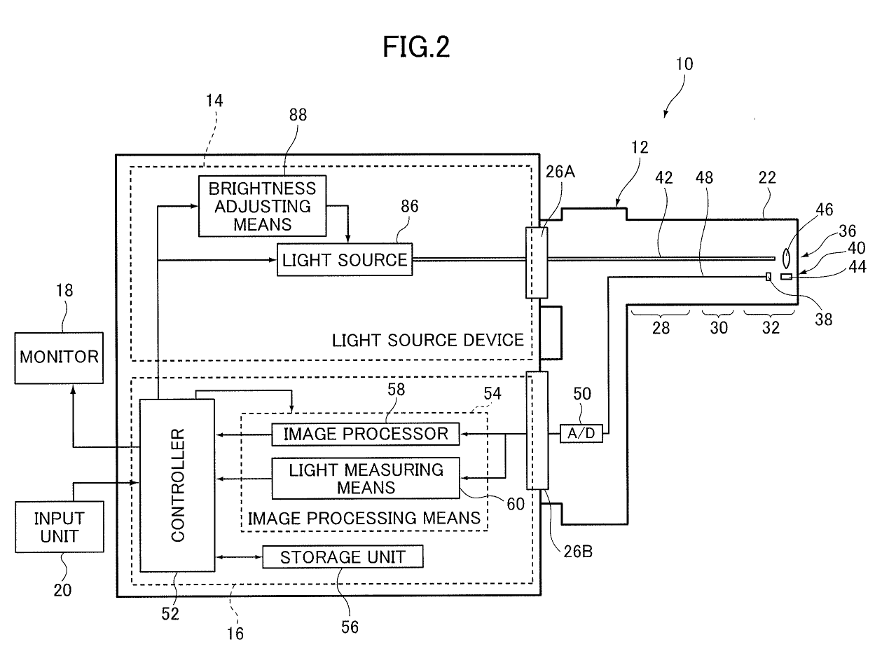

FIG. 1 is an external view of an embodiment illustrating a configuration of the endoscopic diagnosis system according to the invention; FIG. 2 is a block diagram illustrating an internal configuration thereof. As illustrated in these figures, the endoscopic diagnosis system 10 comprises a light source device 14 for emitting illumination light; an endoscope device 12 for guiding illumination light emitted from the light source device 14, irradiating a subject's region under observation with the guided light, and imaging the reflected light to output an image signal; a processor 16 for image-processing the image acquired by the endoscope device 12 to output an endoscopic image corresponding to the illumination light, etc.; a monitor 18 for displaying the endoscopic image and the like obtained through image processing by the processor 16; and an input unit 20 for receiving an input operation.

The input unit 20 sets an imaging menu, an imaging condition, and the like and gives an instruction for imaging the subject. The input unit 20 comprises entry keys for setting an imaging menu and an imaging condition and instruction means for giving an imaging instruction.

The endoscopic diagnosis system of the invention has two kinds of mask, of which one may be selected, for defining a display region when displaying an acquired image on the monitor 18. A halation reduction level can be selected for reducing a halation that occurs in an acquired image displayed on the monitor 18 by adjusting the light amount of the illumination light emitted from the light source device 14. These features will be described later in detail.

The input unit 20 is provided to enter an instruction for selecting and setting the mask and the halation reduction level.

The input unit 20 supplies a controller 52 with an instruction signal according to an entered instruction.

The endoscope device 12 is an electronic endoscope comprising an optical illumination system for emitting illumination light from the tip of an endoscope insertion section 22 inserted into the inside of the subject's body and an optical imaging system for imaging the region to be observed. The endoscope device 12 comprises the endoscope insertion section 22, an operating unit 24 for bending the tip of the endoscope insertion section 22 and performing an operation for observation, and connectors 26A, 26B for detachably connecting the endoscope device 12 to the light source device 14 and the processor 16.

The endoscope insertion section 22 comprises a flexible portion 28 having a flexibility, a bending portion 30, and a tip 32 (also referred to below as tip of the endoscope).

The bending portion 30 is provided between the flexible portion 28 and the tip 32 and is so configured as to be bendable by rotating an angle knob 34 provided on the operating unit 24. The bending portion 30 can be bent in any direction and to any angle according to the subject's site and the like for which the endoscope device 12 is used, so that the observation direction of an emission outlet 36 at the tip 32 of the endoscope and an image sensor 38 can be directed toward a desired site for observation.

At the tip 32 of the endoscope are provided the emission outlet 36 for emitting light to a region under observation and an observation window 40 for imaging the light reflected from the region under observation as illustrated in FIG. 2.

Behind the emission outlet 36, an optical system including a lens 46 is installed; further inwardly, an optical fiber 42 serving as light guide is installed. The optical fiber 42 extends from the light source device 14 through the connector 26A to the tip 32 of the endoscope.

The light emitted from the light source device 14 is guided by the optical fiber 42 to the tip 32 of the endoscope and, passing through the lens 46, leaves the emission outlet 36 to irradiate the subject's region under observation.

At this time, the light thus emitted from the light source device 14 has been adjusted to an appropriate brightness based on the photometric result obtained by the processor 16 described later.

Behind the observation window 40, an optical system including an objective lens unit 44 for introducing image light from the subject's region under observation and, further inwardly, an image sensor 38 such as a CCD (Charge Coupled Device) image sensor and a CMOS (Complementary Metal-Oxide Semiconductor) image sensor for acquiring image information on the subject's region under observation is installed.

The reflected light from the subject's region under observation irradiated with light is condensed by the object lens unit 44, whereupon a white light image is acquired by the imaging sensor 38.

An imaging signal of an image outputted from the image sensor 38 (analog signal) travels through a scope cable 48 to enter an A/D converter 50. The A/D converter 50 converts the imaging signal (analog signal) supplied from the image sensor 38 to a digital image signal (digital signal). The converted image signal passes through the connector 26B to enter image processing means 54 of the processor 16.

The operating unit 24 and the endoscope insertion section 22 contain therein a forceps channel for inserting a tissue collecting tool and the like, air supply/water supply channels, and other like channels, not shown.

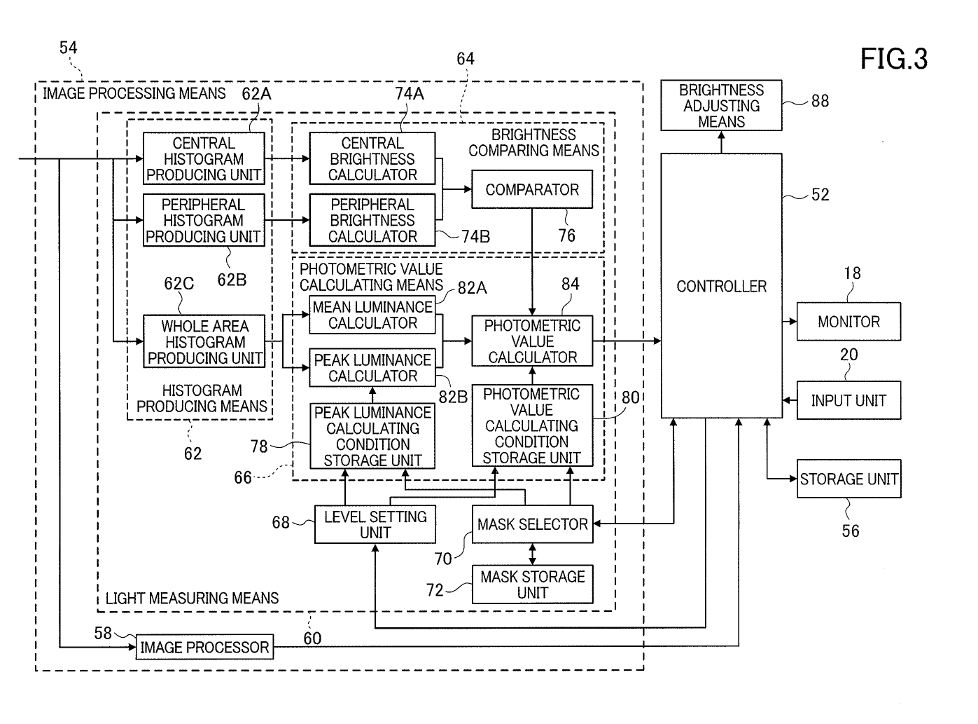

FIG. 3 is a block diagram illustrating a configuration of a part of the endoscopic diagnosis system of FIG. 1.

The processor 16 comprises the controller 52, the image processing means 54, and a storage unit 56. The controller 52 is connected to the monitor 18 and the input unit 20. The processor 16 image-processes the image signal entered from the endoscope device 12 based on an instruction entered from the input unit 20, produces a display image, outputs the display image to the monitor 18, and controls the light source device 14 based on a photometric value representing the brightness of the image calculated by light measuring means 60 of the image processing means 54.

The controller 52 controls the operations of the image processing means 54 and the light source device 14 based on instructions from the input unit 20.

The controller 52 further provides a control to have the acquired image displayed on the monitor 18. The acquired image is displayed on the monitor 18 with a display region defined (masked) according to a mask supplied from the mask selector 70.

The controller 52 controls the operation of the light source device 14 according to the photometric value supplied from the image processing means 54.

In this embodiment, the input unit 20 receives instruction for selecting a mask for defining the display region of the acquired image to be displayed on the monitor 18 and a halation reduction level; the mask selection instruction and the halation reduction level instruction are supplied to the image processing means 54.

The image processing means 54 performs a given image processing on the image signal entered from the endoscope device 12 under the control by the controller 52. The image signal processed by the image processing means 54 is supplied to the controller 52, which produces an endoscopic observation image from this processed image and other information. The endoscopic observation image is displayed on the monitor 18 and, where necessary, stored in the storage unit 56 comprising a memory and a storage device.

The image processing means 54 measures the brightness of the acquired image to obtain the photometric value. The photometric value obtained by the image processing means 54 is supplied to the controller 52, which controls the light source device 14 according to the photometric value.

The image processing means 54 comprises an image processor 58 and the light measuring means 60.

The image signal of a moving image, which is a digital signal produced by the A/D converter 50, is supplied to the image processor 58. A still image is extracted as appropriate from among a plurality of frames of still images constituting the image signal of a moving image, a digital image produced by the A/D converter 50, and supplied to histogram producing means 62 of the light measuring means 60.

The image processor 58 performs a given image processing on the supplied image signal of a moving image and outputs a processed image signal of a moving image. Image processing includes, for example, white balance correction, gamma correction, contour enhancement, and color correction.

The image processor 58 supplies the processed image signal of a moving image to the controller 52. The controller 52 provides a control to display the processed image signal of a moving image on the monitor 18.

The processed image signal of a moving image is stored in the storage unit 56, the unit being, for example, one frame of image.

The light measuring means 60 measures the brightness of the acquired image to obtain the photometric value.

The light measuring means 60 comprises histogram producing means 62, brightness comparing means 64, photometric value calculating means 66, a level setting unit 68, the mask selector 70, and a mask storage unit 72.

The mask storage unit 72 stores a plurality of masks for defining the display region of the image (moving image) displayed on the monitor 18. The masks stored in the mask storage unit 72 are used to provided an electronic masking; the controller 52 effects masking of the image signal of a moving image in such a manner that data of an image representing a region other than the display region is not displayed on the monitor 18.

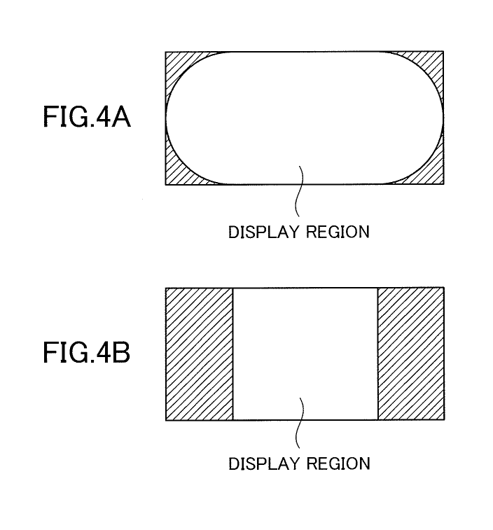

In this embodiment, the mask storage unit 72 stores two kinds of mask illustrated in FIGS. 4A and 4B.

A mask A conceptually illustrated in FIG. 4A allows an image to be displayed in a shape having a pair of opposite, arc-shaped sides. A mask B conceptually illustrated in FIG. 4B is a mask having a rectangular display region whereby the two opposite regions on both sides of an image, each side having a given width, are not displayed.

The shape of the masks used in the endoscopic diagnosis system 10 of the invention is not specifically limited. The number of stored masks is also not limited and may, for example, be three or more.

The mask selector 70 reads out a mask stored in the mask storage unit 72 according to the instruction from the controller 52 and supplies the mask to the controller 52. The mask selector 70 supplies information on the selected mask to the peak luminance calculating condition storage unit 78 of the photometric value calculating means 66 and the photometric value calculating condition storage unit 80.

The level setting unit 68 is used to set the halation reduction level according to an instruction from the controller 52. Specifically, there are provided a moderate mode for reducing the halation by a small ratio, an intensive mode for reducing the halation by a great ratio, and a medium mode between them for reducing the halation by a medium ratio. One of the modes is selected according to an instruction from the input unit 20.

The level setting unit 68 supplies information on the selected halation reduction level to the peak luminance calculating condition storage unit 78 of the photometric value calculating means 66 and the photometric value calculating condition storage unit 80.

When the halation reduction level is set to the intensive mode, for example, the peak luminance calculating condition storage unit 78 and the photometric value calculating condition storage unit 80 respectively so select a peak luminance calculating condition and a photometric value calculating condition that the photometric value is calculated in such a direction as to reduce the halation, i.e., in such a direction as to reduce the amount of illumination light emitted from the light source device 14 This point will be described in detail later.

The number of modes for reducing the halation is not limited to three and may be two or more than three.

The histogram producing means 62 produces a histogram showing brightness at various points of a supplied still image and supplies the histogram to the brightness comparing means 64 and the photometric value calculating means 66.

The histogram producing means 62 comprises a central histogram producing unit 62A, a peripheral histogram producing unit 62B, and a whole area histogram producing unit 62C.

The central histogram producing unit 62A produces a histogram of a central area containing the center of a supplied still image (center-of-image histogram).

The peripheral histogram producing unit 62B produces a histogram for a peripheral area closer to the periphery surrounding the central area of a supplied still image (periphery-of-image histogram).

The whole area histogram producing unit 62C produces a histogram for the whole area of a supplied still image (whole image histogram).

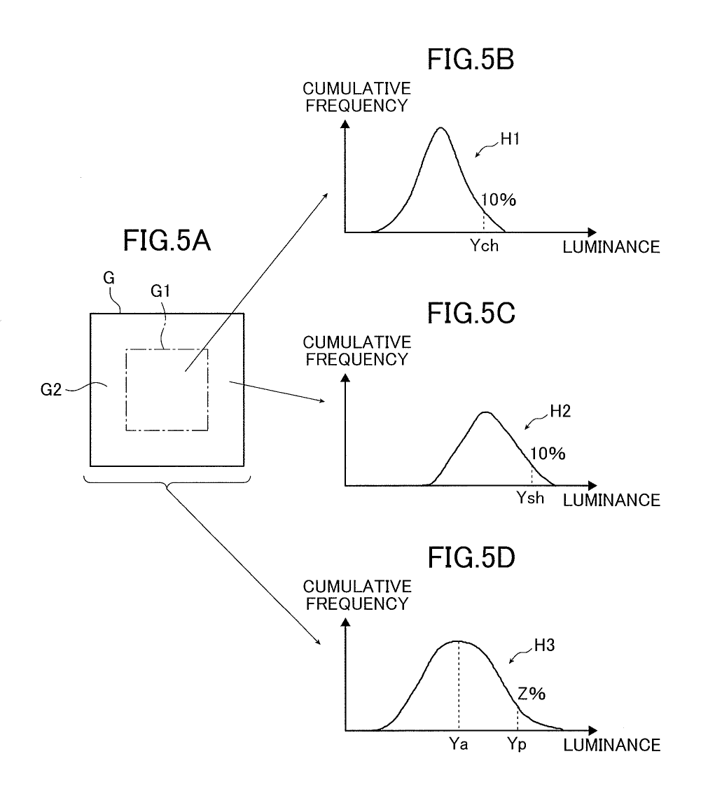

FIGS. 5A to 5D are schematic views illustrating a center-of-image histogram, a periphery-of-image histogram, and a whole-image histogram.

FIG. 5A illustrates a still image G, a central area G1 containing the center of the still image G, and a periphery G2 closer to the periphery surrounding the central area G1. The central area G1 corresponds to an example of a first region of the present invention; the peripheral area G2 corresponds to an example of a second region of the present invention.

FIG. 5B illustrates a center-of-image histogram H1, which is a histogram corresponding to the central area G1; FIG. 5C illustrates a periphery-of-image histogram H2, which is a histogram corresponding to the peripheral area G2; FIG. 5D illustrates a whole image histogram H3, which is a histogram corresponding to the whole area of the still image G. In the example shown in FIG. 5A, the brightness distribution in the central area G1 is biased toward the darker side as compared with the brightness distribution in the peripheral area G2 as will be seen from FIGS. 5B and 5C.

The center-of-image histogram H1 produced by the central histogram producing unit 62A is supplied to a central brightness calculator 74A of the brightness comparing means 64.

The periphery-of-image histogram H2 produced by the peripheral histogram producing unit 62B is supplied to a peripheral brightness calculator 74B of the brightness comparing means 64.

The whole image histogram H3 produced by the whole area histogram producing unit 62C is supplied to a mean luminance calculator 82A and a peak luminance calculator 82B of the brightness comparing means 66.

The size of the central area G1 of the image is not specifically limited, and preferably has an area ratio of 25% to 50% of the whole image. Thus, the brightness of the image can be more desirably adjusted to a more appropriate brightness.

The size of the peripheral area G2 of the image is also not specifically limited and preferably has an area ratio of 50% to 75% of the whole image. Thus, the brightness of the image can be more desirably adjusted to a more appropriate brightness.

Although in the illustrated example the central area G1 and the peripheral area G2 bordering on and surrounding the central area G1 are described above as examples of the first region and the second region, the present invention is not limited thereto. The first region and the second region of the invention may have a gap between them or the second region may surround the first region with a part of the surrounding periphery missing.

Although the above example of the first region of the invention is a rectangular central area, the present invention is not limited this way; the shape of the first region of the invention may be, for example, a circle or an ellipse, or a polygon other than a rectangle such as a triangle or a pentagon.

The brightness comparing means 64 uses the center-of-image histogram H1 and the periphery-of-image histogram H2 supplied from the histogram producing means 62 to compare the brightness in the central area of the still image and the brightness in the periphery.

The brightness comparing means 64 comprises the central brightness calculator 74A, the peripheral brightness calculator 74B, and a comparator 76.

The central brightness calculator 74A uses the center-of-image histogram H1 supplied from the histogram producing means 62 to calculate the brightness in a high-luminance area of the central area G1.

The central brightness calculator 74A calculates a luminance (central peak luminance) Ych, where the cumulative frequency becomes 10% as seen from the higher luminance side in the center-of-image histogram H1 illustrated in FIG. 5B, as a brightness in a high-luminance area of the central area G1.

The central brightness calculator 74A supplies information on the calculated brightness in the central area G1 (central peak luminance Ych) to the comparator 76.

The peripheral brightness calculator 74B uses the periphery-of-image histogram H2 supplied from the histogram producing means 62 to calculate the brightness in a high-luminance area of the peripheral area G2.

The peripheral brightness calculator 74B calculates a luminance (peripheral peak luminance) Ysh, where the cumulative frequency becomes 10% as seen from the higher luminance side in the periphery-of-image histogram H2 illustrated in FIG. 5C, as a brightness in a high-luminance area of the peripheral area G2.

The peripheral brightness calculator 74B supplies information on the calculated brightness in the peripheral area G2 (peripheral peak luminance Ysh) to the comparator 76.

Although in the illustrated examples, the central brightness calculator 74A and the peripheral brightness calculator 74B calculate luminances (peak luminances) where the cumulative frequency becomes 10% as seen from the higher luminance side as the brightnesses in the central area G1 and the peripheral area G2, respectively, the present invention is not limited thereto; the mean luminance may be calculated as the brightness.

The comparator 76 compares the central peak luminance Ych and the peripheral peak luminance Ysh supplied form the central brightness calculator 74A and the peripheral brightness calculator 74B.

The comparator 76 calculates a ratio Ych/Ysh of the central peak luminance Ych to the peripheral peak luminance Ysh. The greater the ratio, the brighter the central area G1 becomes with respect to the peripheral area G2.

The comparator 76 supplies the calculated ratio Ych/Ysh to a photometric value calculator 84 of the photometric value calculating means 66.

The photometric value calculating means 66 calculates the photometric value from the whole image histogram H3 supplied form the whole area histogram producing unit and the ratio Ych/Ysh supplied from the comparator 76.

The photometric value calculating means 66 comprises the peak luminance calculating condition storage unit 78, the photometric value calculating condition storage unit 80, the mean peak luminance calculator 82A, the peak luminance calculator 82B, and the photometric value calculator 84.

The photometric value calculating means 66 supplies the calculated photometric value to the controller 52.

The peak luminance calculating condition and the photometric value calculating condition (mixing condition), which are the calculating conditions for the photometric value calculating means 66 to calculate the photometric value, are so set according to the selection of the mask that the greater the angle of view of the mask (angle of view of the masked image), the greater the photometric value becomes. These conditions are also so set according to the halation reduction level that the higher the halation reduction level, the greater the photometric value becomes.

The mean luminance calculator 82A calculates a luminance Ya (whole mean luminance) that equally divides the area surrounded by the curve of the whole image histogram H3 in the whole image histogram H3 supplied from the histogram producing means 62 as a mean brightness in the still image G.

The mean luminance calculator 82A supplies the calculated whole mean luminance Ya to the photometric value calculator 84.

The peak luminance calculator 82B calculates a luminance (whole peak luminance) Yp, where the cumulative frequency becomes z % as seen from the higher luminance side in the whole image histogram H3 supplied from the histogram producing means 62, as a brightness in a high-luminance area of the still image G.

The cumulative frequency z % for calculating the whole peak luminance Yp, i.e., a peak luminance calculating condition, is supplied from the peak luminance calculating condition storage unit 78.

The peak luminance calculator 82B supplies the calculated whole peak luminance Yp to the photometric value calculator 84.

The peak luminance calculating condition storage unit 78 sets the peak luminance calculating condition, i.e., the cumulative frequency z %, for calculating the peak luminance in the peak luminance calculator 82B.

The peak luminance calculating condition storage unit 78 stores a plurality of the calculating conditions for calculating the peak luminance according to the halation reduction levels and kinds of mask.

The peak luminance calculating condition storage unit 78 selects a calculating condition for calculating the peak luminance from halation reduction level setting information supplied from the level setting unit 68 and mask setting information supplied from the mask selector 70.

The peak luminance calculating condition storage unit 78 supplies the selected peak luminance calculating condition to the peak luminance calculator 82B.

Table 1 shows an example of relationship between the halation reduction level and the kind of mask on the one hand and the cumulative frequency z on the other.

TABLE 1

| | Hallation reduction level | | |
|---|---|---|---|
| | moderate | medium | intensive |
| Mask A | 10 | 7 | 5 |
| Mask B | 12 | 10 | 7 |

As shown in Table 1, the cumulative frequency z is so set in the peak luminance calculating condition storage unit 78 that the higher the halation reduction level, the higher the calculated peak luminance becomes, in other words, the smaller the cumulative frequency z becomes.

The higher the set peak luminance, the greater the photometric value that is calculated by the photometric value calculator 84. With a greater photometric value, the controller 52 controls the light source device 14 to reduce the amount of the light emitted by the light source device 14. The smaller the light amount with which the subject is irradiated, the less liable the halation is to occur, thus restricting the occurrence of halation.

Referring to the mask A and the mask B illustrated in FIGS. 4A and 4B, the mask A has the larger angle of view and the broader display region. Accordingly, the chance of halation occurring in the periphery is greater in the mask A than in the mask B. Therefore, when the mask A is selected, the cumulative frequency z is so set as to be smaller than when the mask B is selected.

Since the peak luminance calculating condition for obtaining the photometric value is thus varied depending on the setting of the halation reduction level and the selection of the mask, the brightness in the region on which the doctor's attention is focused for diagnosis can be automatically adjusted to an appropriate brightness even when the region of interest lies in the periphery, and the brightness can be automatically adjusted to an appropriate brightness according to the shape of the mask.

The photometric value calculator 84 calculates the photometric value from the whole mean luminance Ya supplied from the mean luminance calculator 82A and the whole peak luminance Yp supplied from the peak luminance calculator 82B.

The photometric value calculator 84 mixes the whole mean luminance Ya and the whole peak luminance Yp according to the ratio Ych/Ysh of the central peak luminance Ych to the peripheral peak luminance Ysh supplied from the comparator 76 of the brightness comparing means 64 to calculate the photometric value representing the brightness of the whole still image G.

The photometric value calculator 84 uses a weight Wp to mix the whole mean luminance Ya and the whole peak luminance Yp according to Formula (1).

Photometric value=weight Wp×peak luminance Yp+(1−weight Wp)×mean luminance Ya (Formula 1)

The weight Wp is a ratio of the peak luminance Yp in the mixture. The greater the weight Wp, the greater the ratio of the brightness of the high-luminance region in the brightness represented by the obtained photometric value becomes; conversely, the smaller the weight Wp, the greater the ratio of a mean brightness.

The weight Wp is obtained from the ratio Ych/Ysh of the central peak luminance Ych to the peripheral peak luminance Ysh.

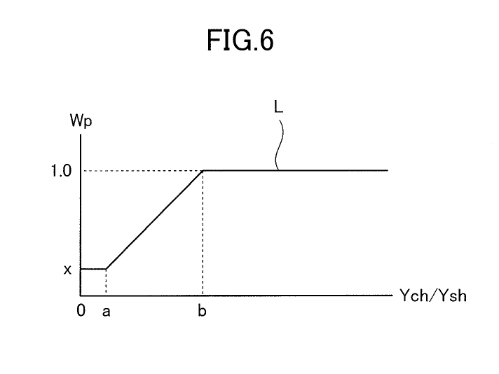

Specifically, the photometric value calculator 84 obtains the weight Wp in accordance with the ratio the Ych/Ysh from the graph shown in FIG. 6. FIG. 6 shows a correlative function expressing the correspondence between the ratio Ych/Ysh of the central peak luminance Ych to the peripheral peak luminance Ysh and the weight Wp. The weight Wp is calculated by substituting the ratio delivered from the comparator 76 in the correlative function.

In the graph shown in FIG. 6, the horizontal axis plots the ratio Ych/Ysh of the central peak luminance Ych to the peripheral peak luminance Ysh; the vertical axis plots the weight Wp. As will be seen from a polygonal line L in the graph, the weight Wp is x (x<1) for a ratio Ych/Ysh that is less than a, in which the peripheral area G2 is overwhelmingly brighter than the central area G1, while the weight Wp is 1.0 for a ratio Ych/Ysh that is greater than b (a<b), in which the central area G1 is overwhelmingly brighter than the peripheral area G2, according to this embodiment. For a ratio (Ych/Ysh) in a range from a inclusive to b inclusive, the weight Wp increases from x to 1.0 in proportion to the ratio Ych/Ysh.

When the weight Wp as described above is applied to the above calculation formula, the higher the brightness in the central area G1 relative to the brightness in the peripheral area G2, the greater the weight Wp becomes, and, as a result, the ratio of brightness of the high-luminance region in the still image G, i.e., the central area G1, where brightness is concentrated, in the brightness represented by the photometric value obtained by the above calculation formula in the photometric value calculator 84 increases. Conversely, the higher the brightness in the peripheral area G2 relative to the brightness in the central area G1, the smaller the weight Wp becomes, with the result that the ratio of a mean brightness in the sill image G increases.

According to the invention, the figure of the polygonal line L for obtaining the weight Wp illustrated in FIG. 6 is varied according to the halation reduction level setting information supplied from the level setting unit 68 and the mask setting information supplied from the mask selector 70.

Specifically, the values x, a, and b shown in FIG. 6 are changed to vary the figure of the polygonal line for obtaining the weight Wp.

Table 2 shows an example of relationship between the halation reduction level and the kind of mask on the one hand and the values x, a, and b showing the figure of the polygonal line L on the other.

TABLE 2

| | Hallation reduction level | | | | | | | | |
|---|---|---|---|---|---|---|---|---|---|
| | moderate | | | medium | | | intensive | | |
| | x | a | b | x | a | b | x | a | b |
| Mask | 0.2 | 0.2 | 3 | 0.45 | 0.20 | 3.0 | 0.5 | 0.2 | 3 |
| A | | | | | | | | | |
| Mask | 0.1 | 0.3 | 4 | 0.35 | 0.25 | 3.5 | 0.4 | 0.2 | 3 |
| B | | | | | | | | | |

As shown in Table 2, the values x, a, and b showing the figure of the polygonal line L are so set in the photometric value calculating condition storage unit 80 that the higher the halation reduction level, the greater the weight Wp becomes.

As will be known from the formula 1, the greater the weight Wp, the greater the contribution of the peak luminance Yp and the greater the calculated photometric value. When the photometric value is great, the controller 52 controls the light source device 14 to reduce the amount of the light emitted by the light source device 14. The smaller the light amount with which the subject is irradiated, the less liable the halation is to occur, thus restricting the occurrence of halation.

Referring to the mask A and the mask B illustrated in FIGS. 4A and 4B, the mask A has the larger angle of view and the broader display region. Accordingly, the chance of halation occurring in the periphery is greater in the mask A than in the mask B. Therefore, the values x, a, and b showing the figure of the polygonal line L are so set that the weight Wp is greater when the mask A is selected than when the mask B is selected.

Thus, the photometric value calculating condition (weight Wp), which is a calculating condition for the photometric value calculating means 66 to calculate the photometric value, is so set according to the selection of the mask that the greater the angle of view of the mask is, the greater the photometric value becomes. The condition is also so set according to the halation reduction level that the higher the halation reduction level, the greater the photometric value becomes.

Since the weight Wp calculating condition for obtaining the photometric value is varied depending on the setting of the halation reduction level and the selection of the mask, the brightness in the region of interest for the doctor giving diagnosis can be automatically adjusted to an appropriate brightness even when the region of interest lies in the periphery, and the brightness can be automatically adjusted to an appropriate brightness according to the shape of the mask.

The figure of the polygonal line L for obtaining the weight Wp is not limited to the figure illustrated in FIG. 6, provided that the weight Wp is so determined that the higher the brightness in the central area G1 relative to the brightness in the peripheral area G2, the greater the weight Wp becomes.

The photometric value calculator 84 delivers the obtained photometric value to the controller 52 as brightness of the still image G as a whole.

The light source device 14 irradiates the subject with illumination light.

The light source device 14 comprises a light source 86 and brightness adjusting means 88.

The light emitted from the light source 86 is led to enter the inlet end of the optical fiber 42 of the endoscope device 12.

The light source 86 is not specifically limited and may use, for example, a xenon lamp; a white light lamp such as a fluorescent lamp and a mercury lamp; and a semiconductor light source such as a laser and an LED.

The brightness adjusting means 88 controls the light amount of the illumination light with which the subject is irradiated.

Under the control by the controller 52, the brightness adjusting means 88 controls the output of the light source 86 according to the photometric value calculated by the photometric value calculating means 66 to control the light amount of the illumination light with which the subject is irradiated.

The brightness adjusting means 88 may adjust the light amount in any way as appropriate; a throttle for physically blocking a part of the light may be disposed on the optical path leading from the light source 86 to the emission outlet 36 to adjust the amount of the illumination light by controlling the light amount blocked by the throttle. Alternatively, light amount adjustment may be achieved by adjusting the shutter speed of an electronic shutter in a CCD.

By so controlling the light emitted by the light source device 14 as to have a light amount in accordance with the photometric value, the illumination applied to the subject is suitably adjusted, and the brightness of the moving image displayed on the monitor 18 is maintained at a brightness in an desirable range, so that occurrence of halation can be limited and the region of interest for the doctor can be prevented from growing excessively dark.

According to the brightness delivered from the photometric value calculator 84, the brighter the central area G1 is relative to the peripheral area G2, the greater the ratio of the brightness of the central area G1 becomes. As a result, when the central area on which the doctor's attention is focused in the moving image displayed on the monitor 18 is so bright that halation is likely to occur, a control whereby a greater weight is given to the brightness in the central area is applied to the illumination, thus avoiding halation in the central area. On the other hand, when the peripheral area is too bright, a control whereby a greater weight is given to a mean brightness of the image rather than the brightness of the peripheral area is applied to the illumination, thus avoiding a problem that the illumination is restricted to such an extent that the central area, an important region, grows too dark. When the region on which the doctor's attention is focused lies in the peripheral area, the brightness in the peripheral area can be automatically adjusted to an appropriate brightness by setting a halation reduction level. Further, the shape of the mask may be used to automatically adjust the brightness to an appropriate brightness.

Thus, the endoscopic diagnosis system 10 according to this embodiment enables image acquisition wherein problems attributable to illumination are reduced in a favorable manner.

Now, the operation of the endoscopic diagnosis system 10 will be described.

An instruction for setting the halation reduction level, selection of the mask, or the like is entered from the input unit 20 to the controller 52 of the processor 16. Then, the controller 52 controls the image processing means 54 and the light source device 14.

The light source device 14 emits white light.

In the endoscope device 12, the white light emitted from the light source device 14 is guided by the optical fiber 42 and, passing through the lens 46, leaves the emission outlet 36 to irradiate the subject's region under observation. The reflected light from the region under observation is condensed by the object lens unit 44, undergoes photoelectric conversion by the imaging sensor 38, and is outputted as imaging signal (analog signal).

The imaging signal is converted through the A/D converter 50 into an image signal (digital signal), which undergoes a given image processing by the image processor 58, and a processed image signal is outputted.

The display region is determined according to a selected mask, and the processed image signal is outputted to the monitor 18, which displays the image.

Simultaneously, the light measuring means 60 is supplied with one still image selected as appropriate from among a plurality of still images constituting an image signal (moving image). The light measuring means 60 calculates the photometric value representing the brightness of the supplied still image. The light measuring means 60 supplies the calculated photometric value to the controller 52. The controller 52 controls the light source device 14 according to the supplied photometric value to control the brightness of the illumination light for illuminating the subject.

The light measuring means 60 may perform measurement of light at any timing as appropriate; for example, the measurement may be made given time intervals, or an instruction specifying the measurement timing may be given from the input unit 20 to perform measurement of light when the instruction is given.

When the observation ends, the endoscope insertion section 22 is retracted from the body cavity of the subject, and the power supply to the components of the system is turned off.

The present invention is basically as described above.

While the invention has been described above in detail, the invention is by no means limited to the above embodiments, and various improvements and modifications may of course be made without departing from the spirit of the present invention.

For example, the present invention may be applied to not only normal image acquisition using white light but special image acquisition using narrowband light or near-infrared light.

While examples where the present invention is applied to the endoscopic diagnosis system are described above, the invention is not limited to these examples, and the present invention may be applied to imaging devices or apparatus in general for performing image acquisition by adjusting the illumination applied to a subject in an appropriate manner.

What is claimed is:

1. An imaging device for acquiring an image with a solid state image sensor, comprising
a mask selector including a plurality of masks for defining a display region used when displaying an acquired image and selecting a mask according to an input instruction; a reduction level selector for selecting a halation reduction level according to an input instruction used when displaying said acquired image, light measuring means for obtaining a photometric value representing a whole brightness of said acquired image, and brightness adjusting means for adjust an imaging condition affecting the brightness of said acquired image based on said photometric value,
wherein said light measuring means comprising; a comparator for comparing said brightness in a first region containing a center of said acquired image and a brightness in a second region closer to a periphery in said acquired image to obtain a luminance ratio between said first region and said second region,
a photometric value calculator for calculating a mean luminance and a peak luminance of said acquired image, and mixing said mean luminance and said peak luminance using weighting factors such that, according to said luminance ratio, a weight given to said peak luminance increases as said brightness in said first region relative to the brightness in said second region increases to obtain a photometric value representing the whole brightness of said acquired image, and
a condition setting unit for setting a peak luminance calculating condition and a weighting factor to use when said photometric value calculator obtains said photometric value, according to a combination of said selected mask and the halation reduction level.

2. The imaging device according to claim 1, wherein said mask includes at least a mask covering four corners of an imaging region of a solid state image sensor and a mask covering a pair of opposite given end regions of a solid state image sensor.

3. The imaging device according to claim 1, wherein said peak luminance calculating condition is so set that said peak luminance increases as the halation reduction level increases.

4. The imaging device according to claim 1, wherein said peak luminance calculating condition is so set that said peak luminance increases as said angle of view of said mask increases.

5. The imaging device according to claim 1, wherein said weighting factor setting condition is so set that a weight given to said peak luminance increases as the halation reduction level increases.

6. The imaging device according to claim 1, wherein said weighting factor setting condition is so set that a weight given to said peak luminance increases as a angle of view of said mask increases.

7. The imaging device according to claim 1, wherein said brightness in said first region is a peak luminance of said first region and said brightness in said second region is a peak luminance of said second region.

8. The imaging device according to claim 1, wherein said brightness in said first region is a mean luminance of said first region and said brightness in said second region is a mean luminance of said second region.

9. The imaging device according to claim 1, wherein an area ratio of said first region to said acquired image as a whole is 25% to 50%.

10. The imaging device according to claim 1, further comprising a light source for illuminating a region to be imaged, and
wherein said brightness adjusting means adjusts the imaging condition affecting the brightness of said acquired image by adjusting an amount of light passing through an optical path at a position on the optical path between the light source and the imaging region.

11. The imaging device according to claim 1, wherein said brightness adjusting means adjusts the shutter speed of an electronic shutter in said solid state image sensor.

12. An endoscopic diagnosis system comprising the imaging device according to claim 1.
